(19) United States
(12) Patent Application Publication
(10) Pub. No.: US 2023/0127570 A1
(43) Pub. Date: Apr. 27, 2023

(54) RELEASABLE CONNECTION SYSTEM

(71) Applicant: Mark Jared Thornley, Logan, UT (US)

(72) Inventors: Mark Jared Thornley, Logan, UT (US); Collin Lewis, Nibley, UT (US)

(73) Assignee: Mark Jared Thornley, Logan, UT (US)

(21) Appl. No.: 17/969,996

(22) Filed: Oct. 20, 2022

Related U.S. Application Data
(63) Continuation-in-part of application No. 29/812,444, filed on Oct. 21, 2021.
(60) Provisional application No. 63/270,202, filed on Oct. 21, 2021.

(51) Int. Cl. B63B 21/04; F16G 11/00; F16G 15/04

(52) U.S. Cl. CPC B63B 21/04; F16G 11/00; F16G 15/04

(57) ABSTRACT

A releasable connection system for watercraft with first and second magnetic members configured to attract each other and releasably lock together through a male-female coupling mechanism. Watercraft can be connected to the first and second magnetic members through apertures with rope. A pivotable release arm releases the male-female coupling mechanism when rotated. Rope can attach to the pivotable release arm through an aperture. Connected watercraft can be released when a user remotely pulls a rope which rotates the pivotable release arm.

### RELATED APPLICATIONS

This application claims priority to U.S. Application Nos. 63/270,202 (as the non-provisional of) and 29/812,444 (as continuation-in-part of), each filed on Oct. 21, 2021.

### BACKGROUND

In various aspects of outdoor recreation, it is desired that two objects be easily connected and released. For example, in water sports and recreation, users of kayaks or canoes, for any number of reasons, may seek to securely connect their respective vessels to travel in tandem or train. Such users may also wish to easily disconnect their vessels to travel again individually. The example of kayaks or canoes is merely one of many connectable objects. The situations calling for the useful connection of two objects are nearly infinite.

Of course, connecting two pieces of equipment is not a novel problem. For millenia, people have been connecting equipment with ropes and knots, chains, cords, and the like. However, there is a lack of OEM and/or aftermarket devices that minimize knot-tying time and optimize ease of installation and operation through a connection and release system. What is needed is a simple, robust connection and release system to minimize installation requirements while optimizing ease of operation in connecting and disconnecting objects, such as, for example, kayaks or canoes.

### SUMMARY OF THE INVENTION

In accordance with the above, a new releasable connection is provided for attaching things such as water vessels using a system comprising: first and second magnetic members configured to attract each other and releasably lock together along a generally longitudinal axis through a male-female coupling mechanism; and a pivotable release arm rotatable about an axis generally perpendicular to the longitudinal axis and configured to release the male-female coupling mechanism. The first and second magnetic members may each connect to separate watercraft through apertures and ropes. The pivotable release arm may also connect to a rope through an aperture and allow a user to release the connected watercraft by rotating the pivotable release arm by remotely pulling one end of the rope.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is a perspective view of one embodiment of a releasable connection system.

FIG. 2 is first side view of one embodiment of a releasable connection system.

FIG. 3 is second side view of one embodiment of a releasable connection system.

FIG. 4 is a top view of one embodiment of a releasable connection system.

FIG. 5 is a bottom view of one embodiment of a releasable connection system.

FIG. 6 is a front view of one embodiment of a releasable connection system.

FIG. 7 is a back view of one embodiment of a releasable connection system.

FIG. 8 is a third, alternate view of one embodiment of a releasable connection system showing first and second members detached.

FIG. 9 is an exploded view of one embodiment of a releaseable connection system.

FIG. 10 is a cross-section view of one embodiment of a releasable connection system.

### DETAILED DESCRIPTION OF THE ILLUSTRATED EMBODIMENT

The present invention in its various embodiments, some of which are depicted in the figures herein, is a releasable connection system

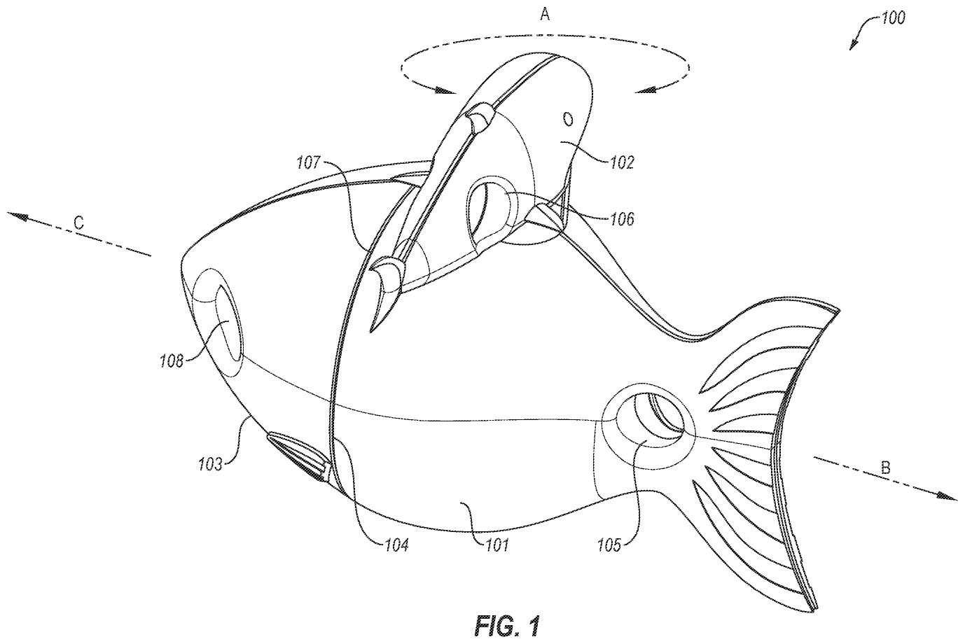

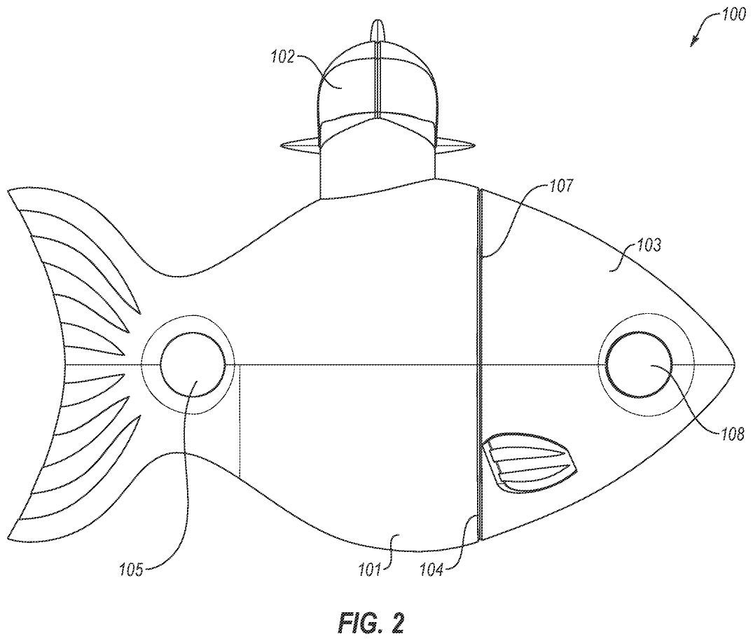

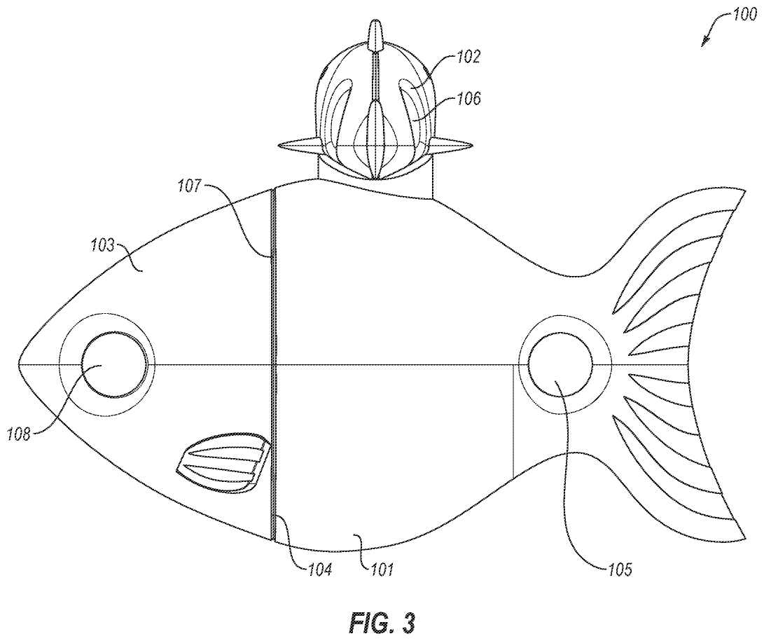

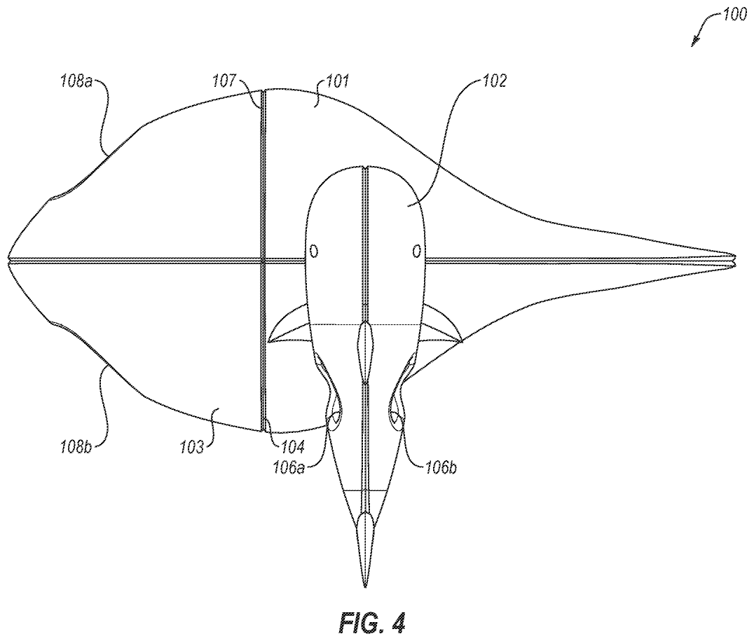

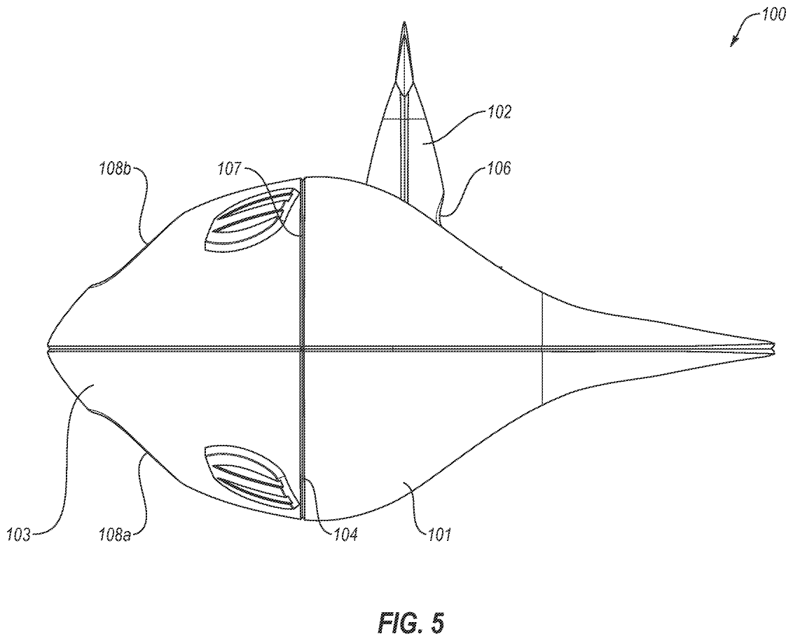

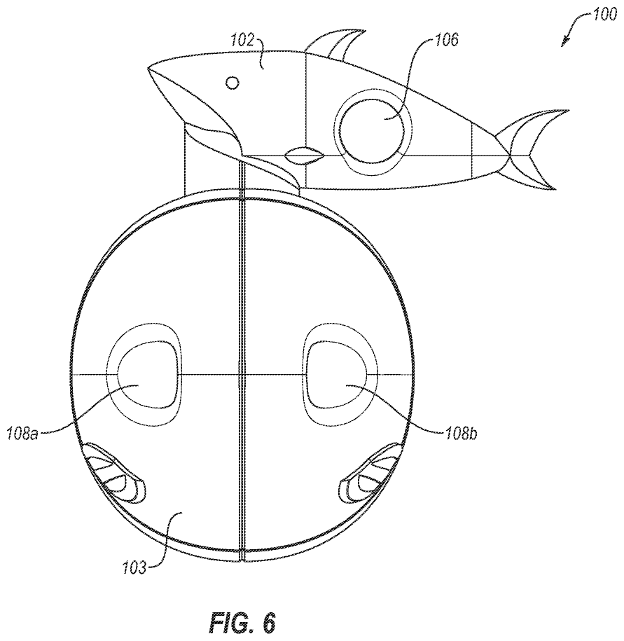

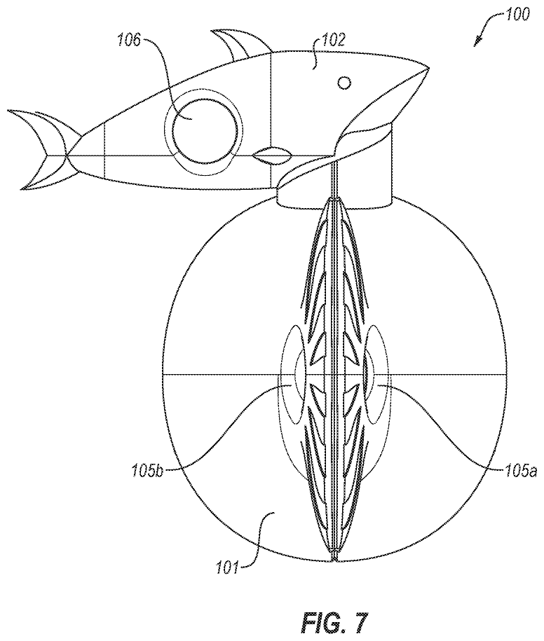

Referring now to FIGS. 1 through 7, an exemplary embodiment of a releasable connection system 100 is shown. Releasable connection system 100 is generally comprised of a first locking member 101 with release arm 102 and a second locking member 103. First locking member 101 may be of many different shapes, for example, generally cylindrical or, in the illustrated embodiment, the caudal end of a fish (from the transverse plane). First locking member 101 has a substantially planar front face 104. First locking member 101 may have an aperture 105 for attachment of one end of ropes, cables, cords, connectors, and the like, which connectors may, in turn, be attachable and/or attached to a first object (such as, for example, a kayak or boat) at another end.

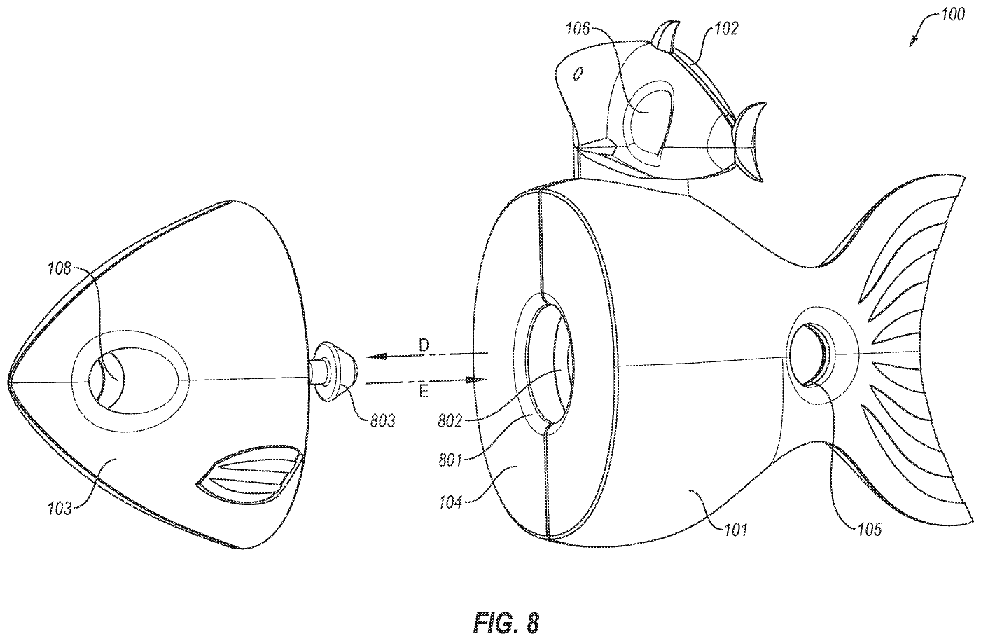

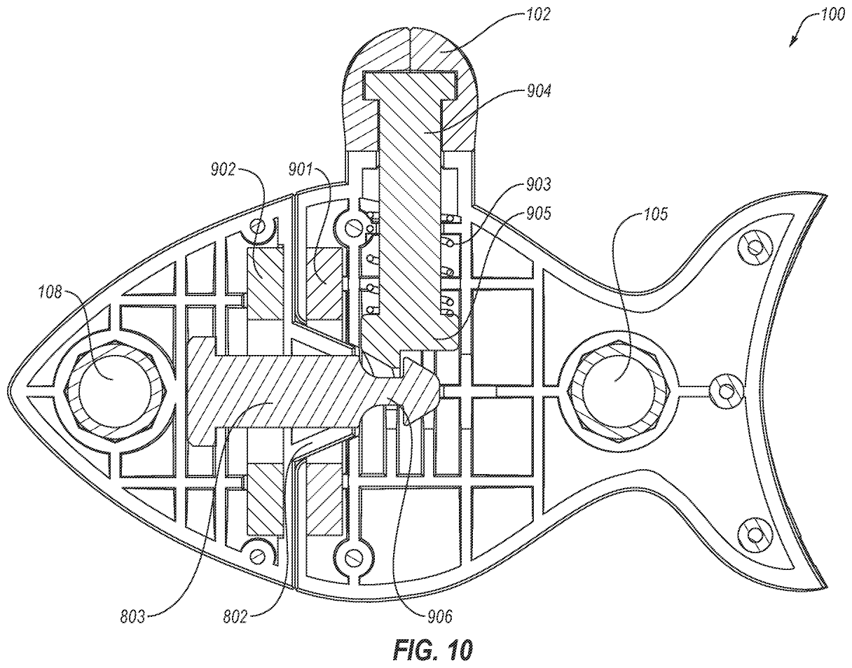

The release arm 102 of the first locking member 101 may be located on or adjacent to a lateral side (in the illustrated example, the dorsal surface) of the first locking member 101 and have an aperture 106 for attachment of one end of ropes, cables, cords, connectors and the like. The release arm 102 is configured to rotate clockwise and/or counterclockwise in, for example, direction A about an axis that is perpendicular to a longitudinal axis of the first locking member 101. Referring briefly to FIGS. 8 through 10, the first locking member 101 may also have a female portion 801 on its face 104, including an aperture 802, configured to receive and secure a male portion locking member 803 through one or more mechanisms described in more detail below. The aperture 802 in the female portion may be funnel shaped in order to optimize entry of the male portion locking member 803 therein.

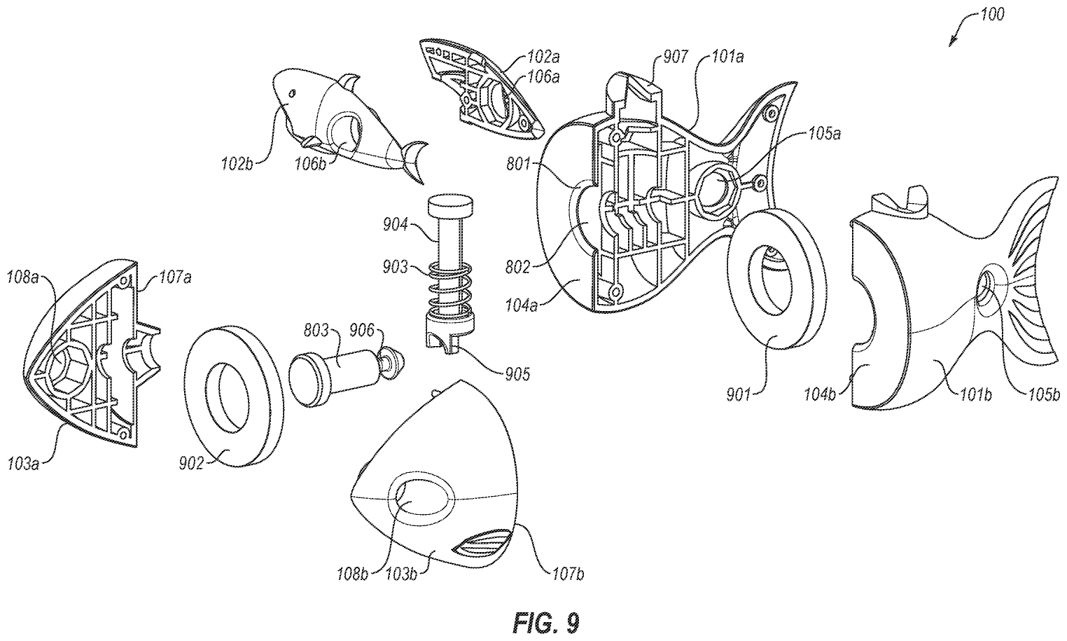

Referring back to FIGS. 1 through 7, second locking member 103 may also be generally cylindrical (or, in the illustrated embodiment, the cranial end of a fish [from the transverse plane] with a substantially planar front face 107. The second locking member 103 may have an aperture 108 for attachment of one end of ropes, cables, cords, connectors, and the like, which may be attached to a second object at another end. Referring briefly to FIGS. 8 and 9, second locking member 103 may also have a male portion locking member 803 configured to engage the female portion 801 of the first locking member 101 through, for example, a structure such as a grooved pin 803, on the male portion side, and spring-loaded detent 903, 904, on the female portion side, the latter housed in the first locking member 101. Referring back to FIGS. 1 through 7, in operation, first locking member 101 and second locking member 103 are configured to separate from each other in directions B and C respectively upon release. Likewise, as shown in FIG. 8, the first locking member 101 and second locking member 103 are configured to join together in directions D and/or E.

Referring now to FIGS. 8 through 10, the lock and release mechanism in one embodiment of the releasable connection system 100 are described in more detail. In various embodiments, the releasable connection system 100 is configured to facilitate initial attraction and/or proximity and connection of and between the first 101 and second 103 locking members through magnets. For example, first locking member 101 may house one or more magnet rings 901 adjacent to its face 104 and second locking member 103 may house a magnet ring 902 adjacent to its face 107.

As set forth above, the male portion locking member 803 of the second locking member 103 is configured to extend into female portion 801 of the first locking member 101. The release arm 102 of the first locking member 101 is in communication with a spring 903 and detent 904, 905 configured to securely engage one or more grooves 906 adjacent an end of the male portion locking member 803 as first 101 and second 103 members are connected. As the release arm 102 of the first locking member 101 is rotated either clockwise or counterclockwise, the release arm 102 moves distally from the first locking member 101 (traveling, e.g., on an inclined surface or edge 907), consequently moving the detent 904 from the groove 906 in the male portion locking member 803 and allowing the first 101 and second 103 locking members to release (if they are engaged or connected together).

An explanation of the operation of one embodiment of the releasable connection system 100 in one exemplary application further shows the utility of the system: first locking member 101 may be secured to boat A while second locking member 103 is secured to boat B. Users of boats A and B may desire to connect their boats. As boat A and B approach each other, first and second locking members initially attract and facilitate the further connection of the male and female portion locking members (through, e.g., a user pushing the members together). Either or both of the users of boat A and B may further attach a rope, cable, cord, connector, and/or the like to the aperture 106 of the release arm 102, such rope may already be attached. The connection of locking members securely established, boat A and B may travel in tandem or train. If and when boat A and/or B desire to disconnect and travel separately, a user simply pulls on the connector attached to the release arm 102 (conveniently, for example, from the location of their vessel) to disengage the locking mechanism and separate first 101 and second 103 locking members.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A releaseable connection system comprising:
first and second magnetic members configured to attract each other and releasably lock together along a generally longitudinal axis through a male-female coupling mechanism; and
a pivotable release arm rotatable about an axis generally perpendicular to the longitudinal axis and configured to release the male-female coupling mechanism.

2. The releasable connection system of claim 1, wherein each of the first magnetic member, second magnetic member, and pivotable release arm has an aperture for connecting one or more of a rope, cable, cord, wire, line, and chain.

3. The releaseable connection system of claim 1, further configured to releasably connect one or more watercraft.

4. The releaseable connection system of claim 1, further configured to allow a user to release one or more watercraft connected by the system by remotely pulling on one or more of a rope, cable, cord, wire, line, and chain attached to the pivotable release arm.

5. The releasable connection system of claim 1, wherein the pivotable release arm is located on one of the first and second magnetic members.

6. The releasable connection system of claim 1, further comprising a generally funnel-shaped female portion within one of the first and second magnetic members configured to facilitate the entry of a male portion within the male-female coupling mechanism.

7. The releasable connection system of claim 2, wherein the pivotable release arm aperture is generally perpendicular to the first and second magnetic member apertures when the first and second magnetic members are releasably locked together.

8. A releaseable connection system for connecting one or more watercraft comprising:
first and second magnetic members configured to attract each other and releasably lock together along a generally longitudinal axis through a male-female coupling mechanism; and
a pivotable release arm rotatable about an axis generally perpendicular to the longitudinal axis and configured to release the male-female coupling mechanism;
wherein each of the first magnetic member, second magnetic member, and pivotable release arm has an aperture for connecting one or more of a rope, cable, cord, wire, line, and chain; and
wherein the releasable connection system is further configured to allow a user to release one or more watercraft connected by the system by remotely pulling on one or more of a rope, cable, cord, wire, line, and chain attached to the pivotable release arm.

9. The releasable connection system for connecting one or more watercraft of claim 8 wherein the pivotable release arm is located on one of the first and second magnetic members.

10. The releasable connection system for connecting one or more watercraft of claim 8, further comprising a generally funnel-shaped female portion within one of the first and second magnetic members configured to facilitate the entry of a male portion within the male-female coupling mechanism.

11. The releasable connection system of claim 8, wherein the pivotable release arm aperture is generally perpendicular to the first and second magnetic member apertures when the first and second magnetic members are releasably locked together.

12. A releaseable connection system for connecting watercraft comprising:
a first locking member
with first and second ends,
a magnetic face adjacent to the first end,
a first aperture located adjacent the second end for connecting the first locking member to a first watercraft through one or more of a rope, cable, cord, wire, line, and chain, and
a pivotable release arm generally located between the magnetic face and first aperture, the pivotable release arm having a second aperture for attaching one or more of a rope cable, cord, wire, line, and chain; and
a second locking member
with first and second ends,
a magnetic face adjacent to the first end,
a third aperture located adjacent the second end for connecting the second locking member to a second watercraft through one or more of a rope, cable, cord, wire, line, and chain, and
the magnetic faces of first and second locking members configured to attract and compatibly abut each other, and
the first and second locking members configured to lock together along a generally longitudinal axis through a male-female coupling mechanism and release from each other by rotation of the pivotable release arm about an axis generally perpendicular to the longitudinal axis.

13. The releaseable connection system for connecting watercraft of claim 12, wherein the pivotable release arm aperture is generally perpendicular to the first and second magnetic member apertures when the first and second magnetic members are releasably locked together.

14. The releaseable connection system for connecting watercraft of claim 12, a spring-loaded detent located between and in communication with the pivotable release arm and male-female coupling mechanism.

15. The releaseable connection system for connecting watercraft of claim 14, the male-female coupling mechanism including a male portion with a groove configured to engage the spring-loaded detent.

16. The releaseable connection system for connecting watercraft of claim 14, the pivotable release arm rotatable on inclined surfaces configured to alternately raise and lower the spring-loaded detent.

17. The releaseable connection system for connecting watercraft of claim 14, wherein one or more of the first locking member, second locking member, and pivotable release arm is fish-shaped.
